(19) United States
(12) Patent Application Publication
(10) Pub. No.: US 2002/0089561 A1
(43) Pub. Date: Jul. 11, 2002

(54) Method and apparatus for obtaining information about a dispensed fluid, such as using optical fiber to obtain diagnostic information about a fluid at a printhead during printing

(75) Inventors: Douglas E. Weitzel, Hamilton, NJ (US); Clifford A. Forsythe, Rockaway, NJ (US)

Correspondence Address: SEED INTELLECTUAL PROPERTY LAW GROUP PLLC, 701 FIFTH AVE, SUITE 6300, SEATTLE, WA, 98104-7092, US

(73) Assignee: Therics, Inc., Princeton, NJ

(21) Appl. No.: 10/007,795

(22) Filed: Nov. 9, 2001

Related U.S. Application Data
(60) Provisional application No. 60/247,432, filed on Nov. 9, 2000.
(60) Provisional application No. 60/247,410, filed on Nov. 9, 2000.

(51) Int. Cl. B41J 29/393; B41J 29/38

(52) U.S. Cl. 347/19; 347/6

(57) ABSTRACT

The invention is the use of an optical fiber to bring visual information to a camera or various types of instruments from a printhead as the printhead is printing product. Coherent optical fibers offer the ability to view an actual picture of a process such as drop generation, while requiring minimal space near the drop generator. Optical fibers also permit the observing end of the fiber to move relative to the receiving end while observations are being taken. Images may be acquired and electronically processed in ways that include identifying fluid flow regime and obtaining dimensional information including dimensions of individual drops. Volumetric flow rate may be calculated from the spatial dimension of drops together with timing information. Colorimetric analysis of the returned light may also yield information about the contents of the drop. It is possible to use any of this information as feedback to control operation of the printhead or dispenser.

### CROSS-REFERENCES TO RELATED APPLICATIONS

This application claims the benefit of U.S. Provisional Patent Application No. 60/247,432 filed Nov. 9, 2000, and U.S. Provisional Patent Application No. 60/247,410 filed Nov. 9, 2000, where these two provisional applications are incorporated herein by reference in their entireties.

### BACKGROUND OF THE INVENTION

1. Technical Field

The invention relates generally to optical diagnostics, and more specifically, to using incoherent and coherent fiber optics to transmit detailed visual quantitative and qualitative information about liquid as it is dispensed from a dispenser or printhead.

2. Description of the Related Art

In precision dispensing of liquids, it is useful to have a visual inspection of the liquid drops or liquid structure as the liquid is being dispensed. When the dispenser, nozzle, or printhead is operating in a testing environment, it is usually relatively easy to obtain visual inspection such as by the use of a camera such as a video camera. However, when the dispenser, nozzle or printhead is in actual use for printing or fabrication, such visual inspection is typically more difficult for at least two reasons.

First, during actual production use, the dispenser is typically moving, and cameras and lenses would be too massive to be built into the moving printhead. Second, during actual use it is usually necessary for the dispenser orifice, such as a dispenser or printhead, to be located quite close to a target. In the case of 3-dimensional printing (3DP), the target is a bed of powder located several millimeters away from the dispenser orifice. In other applications the target may be a sheet of paper, or a well in a plate, but always it is close to the dispenser or printhead. Closeness of the printhead to the target increases the positional accuracy of drop placement and minimizes such other effects as in-flight evaporation. However, this close proximity makes it difficult due to the physical constraints to achieve inspection of the fluid drops during actual printing or fabrication.

Measurement of flow rates during microdispensing is also difficult. The process of dispensing is a dynamic process involving hundreds or even thousands of drops per second from each dispenser or nozzle. For some printing technologies, there is drop-to-drop nonrepeatability. Typical flow rates are small and also vary with time, so that conventional in-line flowmeters are not suitable.

Off-line flow rate measurement is typically done by collecting all of the dispensed fluid over a known long period of time and measuring it either gravimetrically or volumetrically. This necessarily involves the assumption that the drops which are dispensed off-line are equivalent to the drops which are dispensed on-line. It also typically requires treating the whole process as an average, assuming that all drops dispensed off-line are identical to each other. This could, for example, miss detecting subtle effects associated with dispensing drops in irregular sequences typical of printing irregular parts, and could also miss irregularities which are truly random. Furthermore, information obtained is minimal, consisting mainly of an average flow rate.

There are applications where obtaining detailed information is of great value. For example, in dispensing of pharmaceuticals or binders for other medical applications, greater accuracy of content is required than is typically required for industrial applications. Also, for quality assurance in critical applications it may be useful to have verification of fluid delivery, even to the level of detail of verification of delivery individual drops. Current off-line flow rate measurement does not provide the detailed visual information about drops as they are dispensed during actual printing.

The three-dimensional printing process (3DP) is described in detail in the following patents: U.S. Pat. Nos. 5,204,055; 5,340,656; 5,387,380; 5,490,882; 5,814,161; 5,775,402; 5,807,437; and 6,036,777; all patents are herein incorporated by reference.

### SUMMARY OF THE INVENTION

Ink-jet printheads for use in the medical products area are typically used to dispense a variety of compounds in very precise amounts. For some medical products, the amount dispensed must be critically controlled, for example, active pharmaceutical ingredients, potent drugs, hormones or proteins. The present invention provides a system and a method of confirming that a droplet was dispensed when commanded by the overall control system. Currently, droplet dispensing can only be confirmed indirectly, as an average over time. This present invention presents a new method of detecting individual droplets in real-time as they are dispensed.

The invention includes the use of incoherent or coherent optical fiber to bring visual information to a photodiode or light intensity detector, or to a camera from a fluid path dispensing from the printhead as the printhead is printing product. Coherent optical fibers offer the ability to obtain optical information and view an actual picture of a process such as drop generation while requiring minimal space near the drop generator.

Optical fibers also permit the observing end of the fiber to move relative to the receiving end while observations are being taken.

Coherent optical fiber bundles transmit actual images. Images may be acquired and electronically processed in ways which include identifying fluid flow regime (e.g., drops or other fluid unit regime) and obtaining dimensional information including dimensions of individual drops or fluid units, and also obtaining information about stream straightness and coherence. Volumetric flow rate may be calculated from the spatial dimension of drops together with timing information. Colorimetric analysis of the returned light may also yield information about the contents of the drop. It is possible to use any of this information as feedback to control operation of the printhead or dispenser to keep the fluid dispensing regime at desired flow conditions.

An incoherent optical fiber signal is light intensity as a function of time. Incoherent optical fiber offers the ability to obtain optical information about a process such as drop generation while requiring minimal space near the drop generator, and also permits the observing end of the fiber to move relative to the receiving end while observations are being taken. The time-dependent light intensity output from incoherent optical fibers can be used to indicate the presence or absence of drops. Furthermore, even though an image is not obtained, the time-dependent light intensity output can be used to identify the stream regime of the flow, and to some extent flow rate. It is possible to use any of this information obtained using either incoherent or coherent fiber bundles as feedback to control operation of the printhead or dispenser.

Monitoring the quantity and the quality of individual drops during printing may be especially important for medical applications in which active drug is being delivered and dosage must be carefully controlled.

Aspects of the present invention include taking measurements; obtaining a picture of fluid dispensing near a printhead while the printhead is actually printing a product; obtaining the picture from a moving printhead when the optical fiber is bending or changing shape as the picture is being transmitted through it; using visual dimensional data and records of numbers and timing of drops to calculate position of dispensed droplets and volumetric flow rate or drop velocity; using colorimetric analysis of the returned light (including possible fluorescence) to obtain information about the chemical content of the drop; and using any of this output as feedback to control or adjust the printing parameters, or as a quality assurance record of the printing process.

One aspect of the invention provides a method of obtaining optical observation of small drops of liquid as they are dispensed during printing or fabrication of product. Another aspect of the invention is to obtain detailed visual observation of small drops of liquid as they are dispensed during printing or fabrication of a product. Another aspect of this invention is to obtain this optical or visual information in a way that requires a minimum of physical space near the dispenser. Yet another aspect of this invention is to obtain this optical or visual information continuously while the dispenser is moving. Still another aspect of this invention is to obtain information about the presence or absence of drops. Another aspect of this invention is to obtain detailed dimensional information about the drops and information about the content of certain chemicals within the drops or the presence of satellites. Yet another aspect of this invention is to use this visual information as feedback to adjust parameters of the printing or dispensing process, or as a record for quality control.

### BRIEF DESCRIPTION OF THE SEVERAL VIEWS OF THE DRAWINGS

FIG. 1 is an isometric view of a three-dimensional printer with optical fiber sensors installed.

FIG. 2 is a flowchart of one embodiment according to the principles of the present invention.

FIG. 3 is a schematic view of a multiple printhead configuration in accordance with the principles of the present invention.

FIG. 4 is a graph of one sequence over time in accordance with the principles of the present invention.

FIGS. 5A-E is a cross-sectional view of various droplet shapes and corresponding droplet detector analog waveforms in accordance with the principles of the present invention.

FIG. 6 is a front elevational view of the dispenser in accordance with the principles of the present invention.

FIG. 7A is a graph illustrating various signals as a function of time and 7B is a flowchart illustrating the electronic signal and the light signal related to the generation of droplet signals in accordance with the principles of the present invention.

FIG. 8 is a flowchart illustrating the application of droplet signals to process decision-making in accordance with the principles of the present invention.

FIG. 9 is a graph of traces illustrating output signals for typical droplet formation in accordance with the principles of the present invention.

FIG. 10 is a graph of traces illustrating output signals for premature first droplets in accordance with the principles of the present invention.

FIG. 11 is a graph of traces illustrating output signals merging first droplets in accordance with the principles of the present invention.

FIG. 12 is a graph of traces illustrating marginally low detection thresholds in accordance with the principles of the present invention.

FIG. 13 is a graph of traces illustrating marginally low detection threshold with baseline shift due to sensor wetting in accordance with the principles of the present invention.

FIG. 14 is a graph of traces illustrating low detection threshold used to measure full packet size in accordance with the principles of the present invention.

FIG. 15 is a graph of traces illustrating first droplets of a sweep indicating smaller first droplets in accordance with the principles of the present invention.

FIGS. 16A-C are graphs illustrating spectra of detector output for different stream qualities in accordance with the principles of the present invention.

FIG. 17 is a flowchart illustrating a coherent linear optical fiber array in accordance with the principles of the present invention.

### DETAILED DESCRIPTION OF THE INVENTION

A system for obtaining information about characteristics of a dispensed fluid, and in particular, an apparatus and corresponding method for using optical fiber to obtain diagnostic information about a fluid as the fluid dispenses from a printhead during printing. Incoherent and coherent fiber optics provide detailed visual quantitative and qualitative information about the liquid as it is being dispensed. Information that may be obtained includes, for example, the presence or absence of a drop, stream regime of the flow, flow rate, chemical content of a drop, and actual photographic images of a drop.

Fiber optics, now used for much of telecommunications, transmit light through a fiber of transparent material. Light remains inside a properly manufactured fiber and can be transmitted long distances, with little loss of intensity, through fibers comparable in diameter to a hair. An incoherent fiber is a fiber in which light exits randomly over the exiting cross-section of the fiber. In a coherent fiber bundle, the portion of fiber cross-section at which light exits maintains a definite spatial relation to the portion of the cross-section at which the light entered. Thus, for example, a picture at the exit of a coherent optical fiber would be as recognizable as at the entrance. Coherent fibers can be thought of as an ordered collection or bundle of many individual incoherent fibers. Coherent optical fiber bundles are known and useful, for example, in applications such as endoscopy and borescopes.

Coherent optical fiber bundles are not as flexible as incoherent fibers, but they are sufficiently flexible for the present application. This flexibility allows the fiber pointing at the drop to be attached to the movable printhead, while the end of the fiber which connects to a camera or light source may be mounted to something which is not movable, such as the chassis of the same machine, light receiving device, or to an output device. The optical fiber will flex every time the printhead moves. The passage of light through the fiber as bending occurs is not affected by the bending.

The invention may be described in more detail with reference to the drawings.

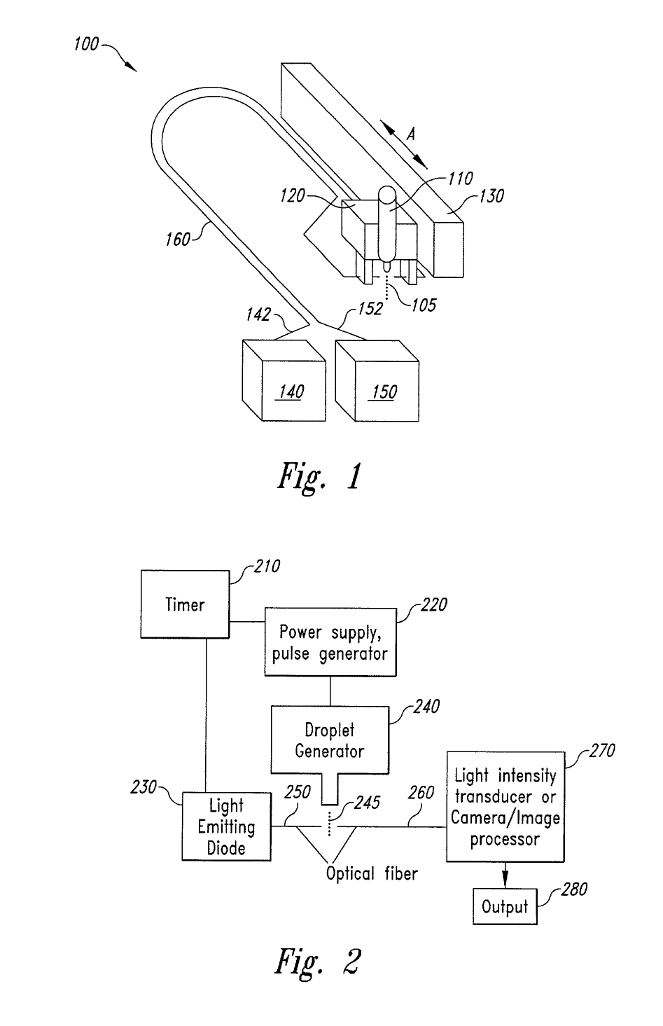

FIG. 1 is an isometric view of a printhead for a three-dimensional printing machine 100 with the optic fiber diagnostics of the present invention installed. The printhead or dispenser 110 for dispensing drops 105 is mounted to a printhead body 120. The printhead body 120 moves along the fast axis in the A direction of a track 130. A light source 140 and a light intensity transducer 150 each connect to a strand of fiber, 142, 152 that forms a pair of flexible optical fibers 160. The fiber strand 142 connected to the light source 140 is mounted at the printhead 110 to bring light to the droplet generation region. The fiber strand 152 connected to the light intensity transducer 150 is mounted at the printhead 110 to receive the light from the light source 140.

FIG. 1 illustrates one embodiment of the present invention in which the light intensity detector or the camera is stationary. Cameras and associated lenses, and even the various forms of light receiving devices that may be used with incoherent fibers are typically too massive to be mounted on the traveling printhead. FIG. 1 further illustrates that the illumination source such as a Light Emitting Diode or other type source is stationary. Alternatively, light from a Light Emitting Diode of sufficiently small mass could be mounted on the printhead. The embodiment, wherein the light is generated at a stationary source and then transmitted by fiber, allows light delivered from the fiber to be aimed. The orientation of the light shown in FIG. 1 is backlighting, wherein the droplet creates a shadow between the light source and the receiver. Backlighting is generally a good orientation for viewing liquid. Other illumination orientations are also possible. For example, when the drop is in the light beam and is blocking light from the receiving optical fiber, some of the incident light will be reflected away by the first surface of the drop in many different directions, out of reach of the light receiving fiber. Some of the light will pass into the drop and then out of the far side of the drop, being refracted also in many different directions, most of them out of reach of the light receiving fiber.

There may be a flexible U-shaped track that is not shown for purposes of clarity in which the fibers are supported during operation of the system. When one end of the fiber moves relative to the other end, the fiber retains the shape of a U, but one leg becomes longer and the other end becomes shorter.

The compactness of optical fibers allows them to be used in areas of limited space. In the present invention, fiber optics are used to obtain visual information about drop formation while a dispenser or printhead is in an operating position close to a powder bed or similar target. A powder bed, not shown for purposes of clarity, is positioned in close proximity and directly below the dispenser 110. Typically, the distance between the powder bed and the discharge orifice of the printhead is only a few millimeters. Maintaining a relatively small distance is important for placement accuracy of drops or fluid units.

FIG. 2 illustrates a flowchart of one embodiment of the present invention. The illustrated embodiment includes a timer 210 coordinating a pulse generated from a power supply 220 providing an actuation signal to generate a droplet 245 from a droplet generator 240. The timer further coordinates with a light emitting diode or strobe 230 to produce a light beam contained in fiber optics 250. The light beam is positioned to direct light across the line of a droplet's flight such that when the droplet passes by and interrupts the light beam, a detector 270 on the far side of the light beam source, registers a decrease in the amount of light. The detector 270 may include a light intensity transducer, or a camera/image processor. Alternatively, a detector on the same side as the source 230 may detect reflected light. The light source 230 may be an array of lasers or laser diodes or a single light source, “piped” to the individual dispenser locations or exit ports by a light guide. The detector 270 detects reflected light through optical fiber 260. Further, the detector 270 may be connected to an output system 280 for in-process data logging.

The light source 230 may generate a precise wavelength of light to eliminate interference of the detector by stray ambient light, or the source 230 may generate “ordinary” light composed of a wide spectrum of wavelengths. The possible wavelengths of light include the visible, infrared and ultraviolet wavelengths of light. Each wavelength may have use in a specific application. A series of detectors 270 would be located adjacent to each dispenser which would consist of detection devices, such as, but not limited to: photodiode arrays, linear Charge Coupled Device arrays, individual CdS (cadmium sulfide) cells, or other light sensitive detectors that are able to detect varying levels of light falling on them.

The quality, quantity, intensity or amount of light falling on the detector 270 can also be used to measure the volume or amount of liquid in the droplet. The quantity of light that is shadowed, or not received by the detector would be indicative of the droplet volume or size; the amount of light that is blocked by the droplet being proportional or related to the drop size. The field of view or illumination may be somewhat larger than the drop size and so typically, when a drop passes through, the intensity of the light collected in the receiving fiber only drops by a fairly small fraction compared to its value when no drop is passing through. This relation may be linear or non-linear. The specific correlation between the effect on the light intensity into the detector as a function of the volume of the droplet or fluid unit may vary for the specific fluid being dispensed. This method allows the confirmation in real-time that a commanded droplet or fluid unit was actually dispensed and also enables the confirmation of the volume of the dispensed droplet or fluid unit.

One advantage of this invention is that each individual droplet or dispensed unit of fluid can be independently detected and confirmed as being dispensed into the medical product. For pharmaceuticals with highly potent, rare, or expensive active pharmaceutical ingredients, accurate control during manufacturing is critical to producing the proper dosage in a given tablet in a cost effective manner. Furthermore, the volume dispensed can be independently verified, thus significantly improving the quality control or quality assurance of fabricated medical and pharmaceutical products.

The detector 270 is optionally connected to a light receiving device 280. The light receiving device 280 may be used for recording in-process data logging. The data may be logged into a computer memory for future downloading. Alternatively, the data could be logged into the same control device which controls the overall operation of the printing machine. Adjustments to process parameters may be made in the form of a feedback loop based on the in-process data, in order to maintain print tolerances. For example, if a preselected unacceptable number of droplet quality or quantity is exceeded, printing of the particular device could be stopped. Alternatively, in-process data could flag particular items for further inspection. In-process data could alternatively be used to track trends for a particular printhead and provide information with respect to the effective life of a printhead or droplet generator 240, or to indicate needed adjustments of process parameters. Detection of a particularly large drop passing the field of view may indicate that a large undesired drop accumulated near the tip of the dispenser and has broken off and fallen to the print job, which is a particularly undesirable event. Detection of this could provide a particularly urgent signal for corrective action, inspection or rejection of a part being manufactured.

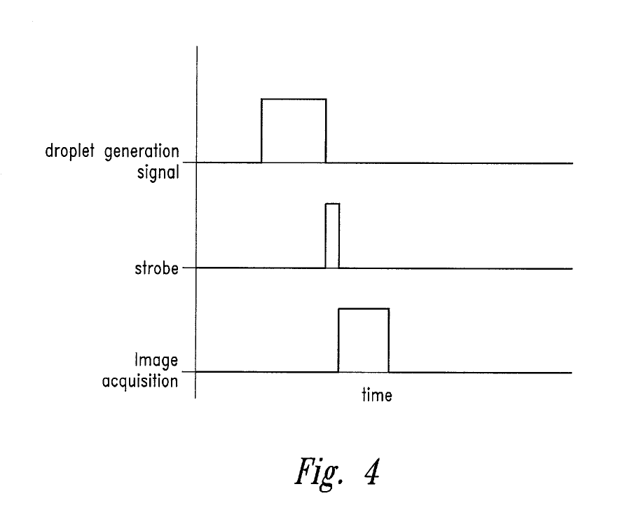

For most purposes, the drop or fluid structure may be illuminated either continuously or stroboscopically. A strobe may be used with a duration of illumination short enough to provide a clear stop-action picture. The strobe illumination is preferably triggered from or synchronized with the droplet generator. There may be included a means for varying the delay of the stroboscopic illumination relative to the signal which operates the fluid dispenser. FIG. 4 illustrates one such synchronization sequence over time between the droplet generation signal, the strobe and the image acquisition.

The illumination source, either continuous or stroboscopic, can be a Light Emitting Diode. Continuous illumination may be preferable with incoherent fiber. The signal is obtained from a light intensity transducer which produces a time-dependent electrical signal whose instantaneous magnitude is related to the instantaneous light intensity.

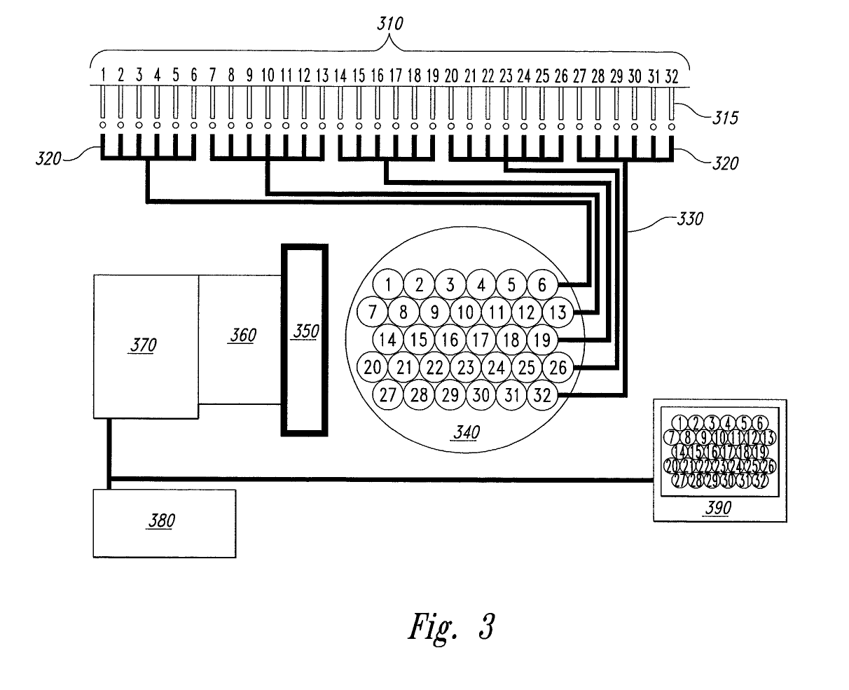

In FIG. 1, light is only shown as passing through the drop region in parallel rays, with no spreading or divergence. However, divergence of light is possible as a natural occurrence of light exiting from the supplying optical fiber. It would further be possible to introduce small lenses in the vicinity of the fiber to enhance magnification, although these are not necessary and are not shown in the illustration. FIG. 1 shows the detection system 100 with one dispenser 110 and one channel of detection. Typically printheads have multiple dispensers, perhaps 4, 8 or 16 or even 32. If coherent fiber optic bundles are used to provide actual images, depending on the number of fiber optic channels, it may be undesirable to have a separate camera and/or monitor for each dispenser. Accordingly, it would be possible to have one camera look at the image from several channels of optical fiber. This reduces the number of pieces of camera equipment required, although there is some loss of spatial resolution. An illustration of 32 fibers bundled onto one video display is shown in FIG. 3.

FIG. 3 illustrates 32 dispensers 310 operably connected to 32 droplet dispenser 320. Fiber optic coupled to LED illuminators may optionally be included 315 in this embodiment, each fiber optic image conduit feeding into an oriented image bundle 340. A fiber optic bundle provides a camera lens interface 350. The interface connects to the lens assembly 360 and video camera 370. A computer imaging interface 380 may provide a real time video image of droplets on a display monitor 390.

A further embodiment illustrated by FIG. 3 allows the camera 370, the lens assembly 360 and the camera lens interface 350 to be stationary on the machine base. Alternately the camera 370 and the lens 360 assembly could be chosen to be as small and lightweight as possible and they could travel with the printhead. Their output would then be sent to the stationary world by electrical wires that are positioned in a U-bend flexing to accommodate printhead motion. In this embodiment, the optical fiber allows a closer view of the fluid unit as it is dispensed and formed. Optical fiber is very compact with need for space not much larger that the diameter of the fiber itself. Cameras cannot be made to fit such physical space constraints.

Yet another embodiment of the present invention includes using incoherent fiber between the moving printhead assembly and the fluid dispensed, converting it to an electrical signal on the printhead assembly, and bringing the electrical signal to a stationary light intensity transducer through U-bending electrical wires. The incoherent fibers allow a very close view to the dispenser under minimal physical constraints, thus allowing view to the small fluid unit. It is not possible to position the light intensity transducer in such proximity to the dispenser.

After an image is transmitted through a coherent fiber, the image may be acquired and processed electronically in a variety of ways. Hardware (circuit boards) to capture images from video cameras namely, frame grabbers, may be used. Software can be used to electronically process images for recognizing edges, recognizing shapes, and tabulating areas or counting pixels having certain characteristics. Software can further compute dimensional measurements between edges or shapes which have been recognized.

With coherent fiber optics, a receiving fiber brings the picture to a camera. One example of such fibers is from Edmund Scientific (Barrington, N.J.) in the form of fibers containing from 6000 to 15,000 pixels or individual fibers, having active optical diameters of from 0.3 to 0.6 mm, capable of bend radii of from 3 to 6 cm. This number of pixels in a two-dimensional cross-section corresponds to around 100 pixels in each dimension. This resolution is somewhat coarser than the resolution of a typical CCD camera or monitor, but not too much coarser. If there are 100 pixels in a field of view of diameter 0.5 mm, for example, then each pixel corresponds to 5 microns of dimension of the drop being viewed. A typical drop diameter for present applications is in the tens of microns, or, for some of the less-demanding applications, hundreds of microns. Thus, there would be at least tens of pixels in each direction making up an image. It is also possible that some magnification could be obtained before the image enters the coherent optical fiber, by virtue of the spreading angle of light.

The visual information may also be processed to yield dimensional information about the drops or similar fluid structures being dispensed. This dimensional information informs the user about the volumetric dispense rate. If drop diameter is measured, such as by curve-fitting a circle and obtaining its diameter, the volume is related cubically to the diameter. It is also possible for the cross-sectional area of a drop or fluid structure to be determined. This can perhaps be done by counting pixels having certain characteristics such as darkness or light intensity above or below a predetermined threshold. This may be more appropriate for fluid structures such as strings, which are not spherical but which still presumably maintain cylindrical symmetry around the axis which is the principal flow direction. In this case, the volume of a fluid structure is proportional to the 3/2 power of the cross-sectional area

The visual information may also be processed to yield dimensional information about the drops or similar fluid structures being dispensed. This dimensional information informs the user about the volumetric dispense rate. If drop diameter is measured, such as by curve-fitting a circle and obtaining its diameter, the volume is related cubically to the diameter. It is also possible for the cross-sectional area of a drop or fluid structure to be determined. This can perhaps be done by counting pixels having certain characteristics such as darkness or light intensity above or below a predetermined threshold. This may be more appropriate for fluid structures such as strings, which are not spherical but which still presumably maintain cylindrical symmetry around the axis which is the principal flow direction. In this case, the volume of a fluid structure is proportional to the 3/2 power of the cross-sectional area.

At the discharge end of the coherent optical fiber, the light will exit from the fiber and typically will pass through a lens which provides some magnification before the light reaches the camera.

If the camera is capable of sufficiently rapid image acquisition, it would be possible to acquire successive images of the same drop at times separated by a known interval. The velocity of the drop could then be calculated from known positional and time differences.

With coherent fiber, the image, either as-acquired or after processing may reveal fluid mechanic regimes.

Use Of Analog Signal to Indicate Stability of Fluid Stream

Analysis of the analog output signal in the time domain yields information about the stability of the droplet stream. A stable droplet stream is evidenced by the relative absence of jitter in the time between droplets, the time relative to the command signals and the shape and amplitude of the analog signals.

Detecting Stream Regime Directly From an Analog Signal

Another regime which sometimes occurs is a series of alternating large and small discrete drops. The small trailing drops are referred to as “satellites.” Another regime is a series of bulges of fluid connected by thin connecting regions, which may be referred to as a “string of pearls.” Yet another undesirable fluid dispensing regime is when the fluid dispenses as two distinct streams having different paths or directions, referred to as split-streaming. For these reasons the term fluid unit is used to denote the fluid dispensed as a result of one dispense command, and the dispensed fluid may exist as a single discrete drop, but it may also exist as any of the various described geometries, all of which are collectively described by the term fluid unit.

All of these situations are possible regimes of drop dispensing, and it is usually important to know which regime is occurring or to operate in the desired regime. This information can be used as feedback, either manually or automatically, to adjust fluid dispensing parameters which affect the flow or droplet regime. Such parameters include but are not limited to fluid reservoir pressure, velocity, frequency of drop formation and length and/or shape of the electrical pulse driving whatever dispensing technology is in use.

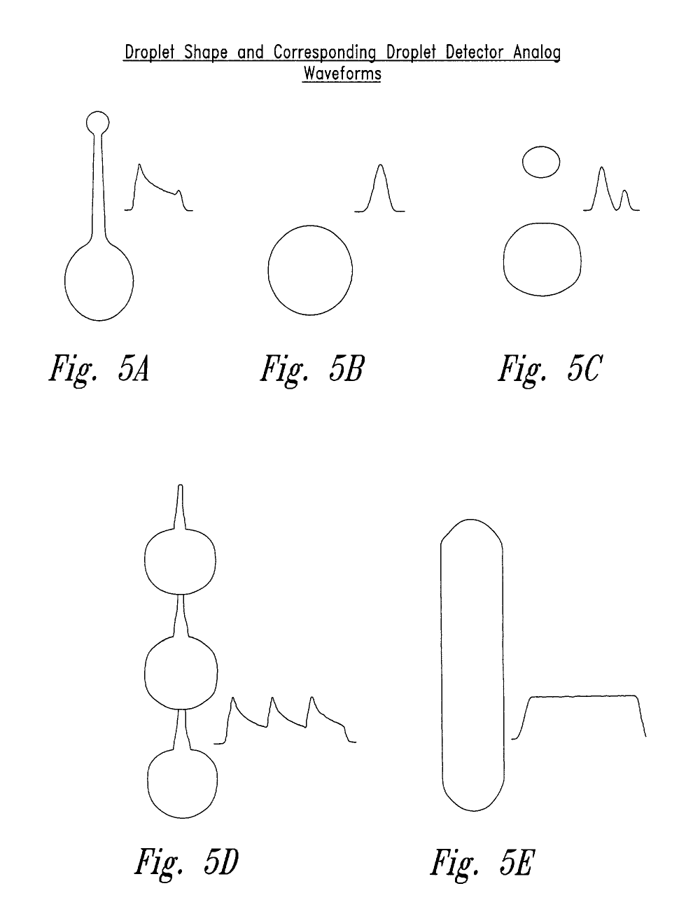

With incoherent fiber, the signal reveals the presence or absence of drops by change in light intensity, and the signal at the earliest stages of processing is an analog signal. The cross-sectional area of the drop or fluid structure creates a shadow by blocking out a portion of the light. The received signal shows a decrease in intensity when a drop is in the field of view. As illustrated in FIG. 5, under aspects of the current invention, it is possible to use the analog signal from incoherent optical fiber used with the inspection method to distinguish between stream regimes. The analog signals shown in FIG. 5 are the analog output from a light intensity transducer after two minor types of signal processing have been performed. The raw analog signal is a signal representing absolute light intensity. When no liquid is present the signal is a full value, constant in time. When a drop or unit of liquid passes through, the intensity decreases by a small fraction.

To obtain the traces shown in FIG. 5, first the constant value is removed such as by AC coupling, and then the resulting signal is inverted (or the same two actions are performed in the opposite order) so that the signal resulting from droplet passage is a positive shape rather than a negative or downward shape, and the signal when no droplet is in the field of view is considered zero. As shown in FIG. 5A, if the stream consists of droplets with a tail, the light intensity signal produced includes a step. As show in FIG. 5B, if the stream consists of well-formed discrete identical drops, the light intensity signal shows approximately spike variations between full intensity and a somewhat reduced intensity. The transitions are somewhat less than perfectly sharp because a drop passes gradually into and out of the field of view. As shown in FIG. 5C, if the stream contains satellite drops, there are two sets of spike-like variations, interspersed with each other. The variation of greater magnitude represents the large droplets and the smaller variation represents the satellite droplets. FIG. 5D illustrates “string of pearls” droplets that never completely detach from each other. This produces a continuous oscillatory variation of light intensity signal, where the intensity never completely returns to its baseline value. FIG. 5E illustrates the resultant light intensity signal if a tremendously oversized drop is ejected from the printhead. The oversized drop shadows and blocks most or all of the field of view of the fiber, and the light intensity will drop nearly to zero and stay there for a relatively long period of time. All of these descriptions depend somewhat on the ratio of the fiber optic field of view to the expected drop diameter, which determines the expected fraction of shadowing or change in light intensity.

In many technologies for dispensing tiny amounts of fluid, especially so-called drop-on-demand dispensing, there is some possibility of nonrepeatability in the volume of an individual drop. For some applications the nonrepeatability of individual drops may be unacceptable. Such detailed information about individual drops is unavailable from conventional methods which involve collecting flow over a known long period of time in a weighed or volume-measured collection vessel. The value obtained from such a process is purely an average and can only inform about variations which occur gradually over a time period longer than the collection period. It is this fact which makes visualization or measurement of individual drops especially valuable.

The visual determination of the volume of individual drops may be used in several ways for feedback and control. First, if on a trend basis the value is not what is desired, this information may be used to adjust dispensing parameters such as details of the electrical waveform driving the dispenser. Second, on a more individual basis, record may be kept of when and where a particular drop was dispensed for purposes of correction. Then, if a drop was undersized, the next time the printhead is scheduled to dispense a drop near that location, the drop may be dispensed so as to be oversized, or extra drops or more closely-spaced drops may be dispensed. A similar correction could be used for errors of oversized drops. The correction could be made on an adjacent printed line, on a subsequent drop in the same line, or in the next layer.

Finally, it is found that occasionally there may be formed a blob or collection of fluid on the dispenser surface near the orifice. This may interact with the exiting drop and occasionally it may join with the exiting drop such that a large blob may be pulled off and ejected instead of the intended small drop. This would be a somewhat random and infrequent event, but it is especially important to detect this when it happens. In this case, detection of a blob could be cause for rejection of an individual printed part.

There is yet another possible way of obtaining information from the light returned from a drop, namely colorimetric analysis of returned light. There are many possible binder fluids and some of them may naturally have color or may be given additives to color them. Returned light which has passed through the drop may contain color information which relates to the quantity of colorant in the drop, which further indicates the composition or mass of the drop. If multiple binders of various color and/or composition are used, colorimetric analysis of returned light can be used to confirm that the correct binder is being dispensed from a given printhead.

Further, the binder fluid may contain or may be modified to contain a known concentration of a compound which fluoresces under the illumination of the incoming light. In this case, the returned light will include light of a very specific frequency whose intensity can be measured. The intensity of this particular light should be indicative of the quantity of a particular chemical in the drop, which further indicates the composition or mass of the drop. Since optical fibers conduct light of many frequencies simultaneously, more than one such analysis could be done simultaneously using the light from a single fiber.

The fluid may be liquid but is not limited to liquid; it could, for example, be viscoelastic, pasty, solid-liquid suspension, emulsion, or the like.

Drop-on-demand (D.O.D.) printheads typically dispense one droplet of a liquid at a time through a small orifice when commanded, for example, by an electrical pulse. Flow rate measurement for this dispensing method is difficult since the fluid flow is in short bursts or fluid units. Flow measurement is either the assumed theoretical value or may consist of commanding the printhead to dispense droplets sufficient to obtain a timed quantity of fluid. The quantity of fluid is weighed or measured for each dispenser and the average effective flow rate for each dispenser is calculated. This procedure must be repeated for each dispenser contained in the printhead assembly. For printheads containing more then a very few dispensers, the time required for this procedure becomes excessive, effectively precluding multiple periodic flow rate measurements.

The present invention determines flow rate in-line and in real time. If incoherent fiber is used, the volume of a single dispensed unit of fluid may be determined by calculating an integral of the amount of shadowing (the drop in the light intensity signal) with respect to time, for a time interval which is the interval between successive dispense commands. This integral represents, in effect, the amount of material that has passed the detector, assuming the material has a cylindrically symmetric geometry. If coherent fiber is used, the method consists of capturing a timed sequence of droplets by employing a data acquisition system, stroboscope and video “frame-grabber” technology to effectively take a snapshot of the droplet stream. Once captured, the video frame image is processed to determine the interval between droplets; this combined with the droplet command rate signal, will provide the average velocity of the droplet train. This velocity, combined with the droplet command rate and a predetermined value of average droplet size, including diameter and volume, is then used to calculate the average flow rate of the dispenser.

The field of view of the optics used with the video camera can be selected to encompass all dispensers on the printhead, providing a single measurement image for all dispensers simultaneously. The droplet velocity/rate and hence flow rate for all dispensers could then be determined by the data acquisition system very rapidly and compared to acceptable reference values. Any flow rate out of the acceptable range could then be either manually or automatically corrected by adjustment to line pressure or by adjustment to the pulse width of firing/actuation chamber or valve. Droplet formation rate could also be adjusted if it is coordinated with the other operating parameters that would be affected.

One advantage of the present invention is increased accuracy. By maintaining closer control over flow rate and flow regime, the accuracy of placing droplets into the powder bed would also increase. Another advantage of the present invention is that droplet velocity is controlled directly. Droplet velocity in turn controls the time of flight of the droplet into the powder bed, which increases the accuracy of the droplet landing in the predetermined position as the printhead scans over the powder bed at constant velocity.

This method can also be applied to continuous jet (CJ) ink-jet printhead technologies. CJ printheads generate a constant stream of electrostatically charged droplets. Droplets that are not to be deposited onto the substrate are electrostatically deflected into a catcher system and removed. With respect to CJ printheads, the periodic command signal generating the droplet formation would be used to trigger the video image grabber. The image would then be analyzed in the same fashion as above. In addition, this method would allow for the adjustment of “phase angle” or lead-lag timing for droplet release from a specific dispenser, hence allowing adjustment of not only individual flow rates but also ensuring that the phase angle of each dispenser's droplet formation is exactly the same across the printhead.

As an enhancement to the method, if the video frame grabber technology has sufficient resolution, the video image could also be analyzed to determine an average droplet diameter, which could then be used as a direct value in calculating flow rate, rather than using a predetermined value.

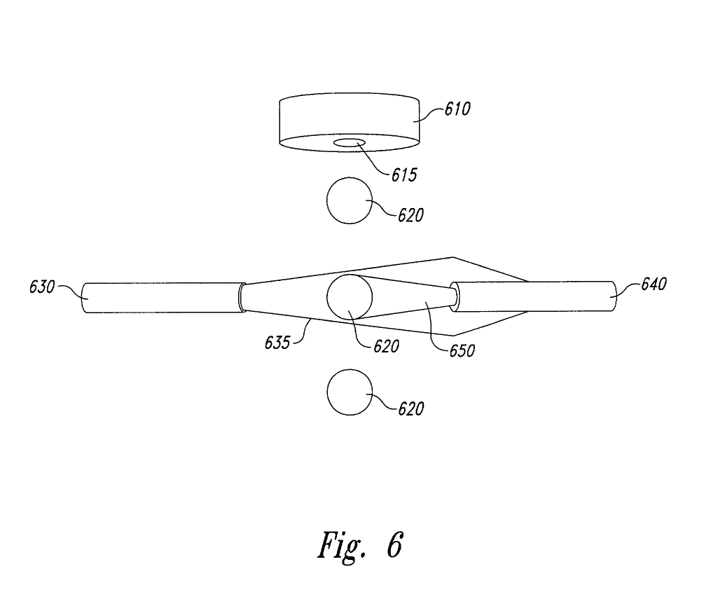

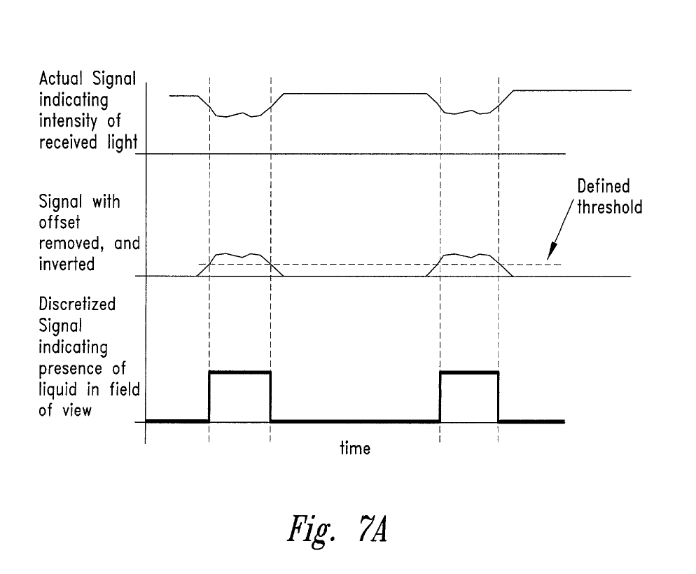

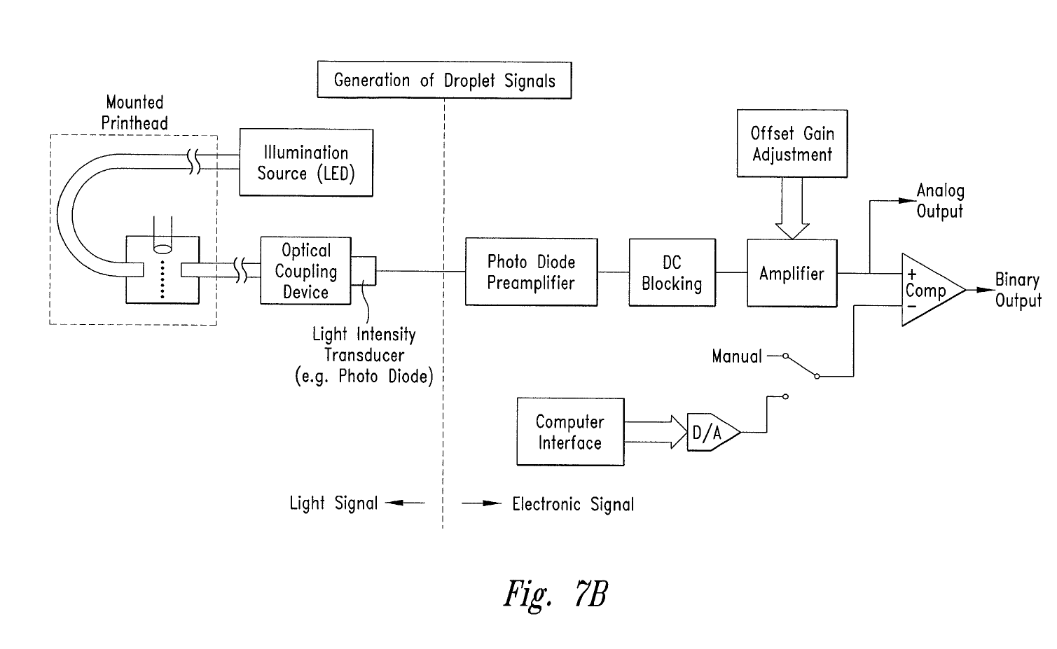

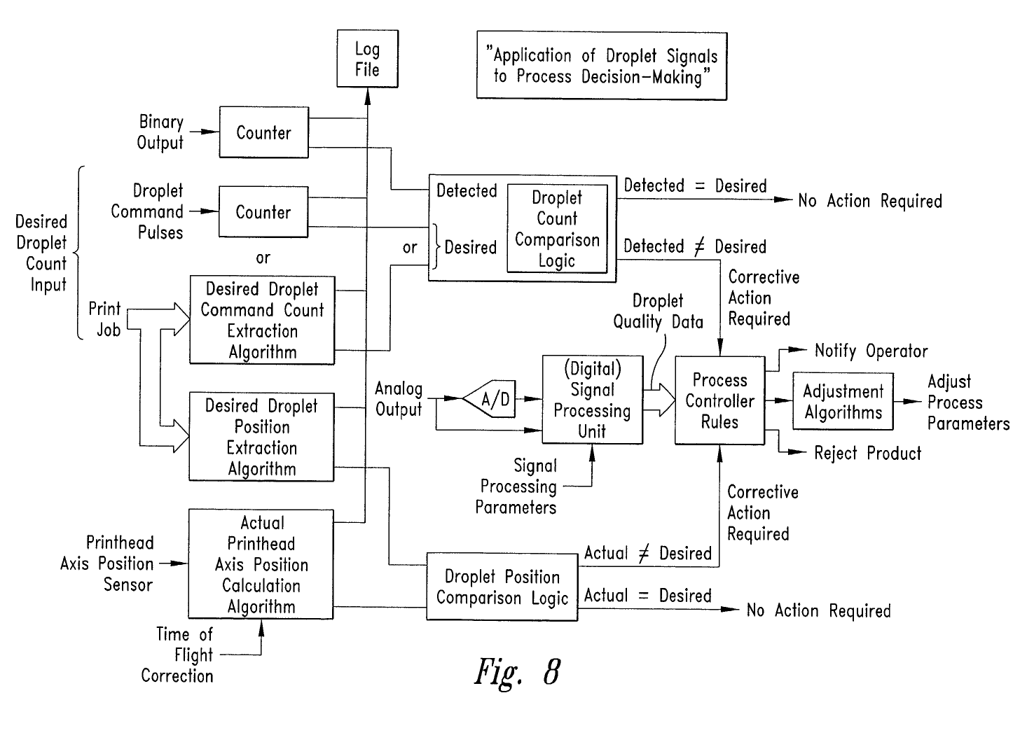

FIG. 6 illustrates a single channel of the sensor configuration. The droplet generator 610 includes an orifice 615 for dispensing drops 620 along a fluid travel path. A transmitter optical fiber 630 transmits a light beam 635 that crosses the fluid travel path. Positioned opposite the transmitter optical fiber 630 is a receiver optical fiber 640. The fluid travel path is between the transmitter and receiver optical fiber. The droplet generator 610 is positioned such that the droplets 620 pass through the light beam 635 emitted by the transmitter optical fiber 630. As the droplets 620 pass through the beam of light 635, a shadow 650 is cast on the receiver optical fiber 640. The received signal shows a decrease in measured light intensity when a drop 620 passes through the beam of light 635. The receiving optical fiber 640 can be either a coherent or incoherent optical fiber.

There is no visual picture of the fluid unit available from the receiving fiber of incoherent optical fiber. Rather, the signal which is available is the intensity of light received by the receiving fiber. The cross-sectional area of the drop or fluid structure creates a shadow by blocking out a portion of the light. The received signal shows a decrease in intensity when a drop is in the field of view. The fractional decrease in light intensity is approximately proportional to the cross-sectional area of the fluid in the field of view, divided by the cross-sectional area of the optical fiber. Factors representing geometric features such as divergence angle of the issued light and acceptance angle of received light may be included.

Discretization of Analog Signal

FIG. 7B is a flowchart illustrating the electronic signal and the light signal related to the generation of droplet signals in accordance with the principles of the present invention. The electric signal includes a photodiode preamplifier, DC blocking, amplifier with offset gain adjustment, manual adjustments to the threshold input, a computer interface, D/A, analog and binary output. The light signal includes a light intensity transducer (e.g. photodiode) and optical coupling device, a mounting to the printhead and illumination source, such as LED.

FIG. 7A is a chart illustrating how the threshold value is used in discretizing a time-varying signal.

FIG. 8 is a flowchart illustrating the application of droplet signals to process decision-making in accordance with the principles of the present invention.

The basic system using an incoherent optical fiber with a discretizer is referred to as Binary Droplet Detection (B.D.D.) The Binary Droplet Detection system detects the passage of binder material through transmissive-regime optical fiber sensors located just below the orifices of the TheriForm™ drop-on-demand printhead. FIG. 6 schematically illustrates a single channel of the sensor configuration.

Light signals from the receiver fibers are converted into electronic signals by preamplifier circuits located remotely. The output of the preamplifier circuit is an analog signal that is proportional to the amount of light present at the end of the receiver fiber. When inverted electronically, it represents the amount of shadow present at the fiber end; that is, the higher the signal level, the greater the amount of shadow, or binder material is present at any instance in time.

Preparation of the signal also involves removing the constant value as an offset, as already described, either before or after the inverting of the signal, so that the signal resulting from droplet passage is a positive shape rather than a negative or downward shape, and the signal when no droplet is in the field of view is considered zero.

To provide binary output, the analog signal is then compared against a detection threshold voltage such that the presence of shadow signal above the threshold will generate a digital “high” or “true” output. This is then compared against a commanded count, or the reference point. The Binary Droplet Detection system counts these digital pulses to determine the number of droplets that pass the detector during printing.

The comparison against a detection threshold voltage to determine the presence of a drop is a discretizer. A discretizer decides when the analog signal level is such that it indicates a drop is passing through the field of view or the signal level is such that it indicates that no drop is present in the field of view. Each continuous portion of time on the discretizer signal with a drop present signal constitutes a drop, and each continuous portion of time with a no drop present signal constitutes not a drop. Optionally, a counter can count the number of drops separated by non-drops.

The fiber optic detection system offers one significant advantage over a system which simply involves pointing an ordinary stationary video camera directly at a droplet stream (which requires the printhead to be stationary, which means it cannot actually be printing but has to be done off-line); multiple droplet streams can be continuously monitored during actual printing. The present invention allows real time monitoring since the detector is mounted directly on the printhead. To add further value, the fiberoptic approach can also provide the vision-like features of inferring droplet geometry and stream stability through relatively simple and inexpensive signal processing techniques. This enables a level of process verification previously not possible on three-dimensional printing (3DP) systems.

FIG. 8 is a flowchart illustrating the application of droplet signals to process decision-making in accordance with the principles of the present invention.

Detection of Major Irregularities

It can happen during three-dimensional printing that a large drop gradually builds up on the dispenser during the course of many dispensed drops or flow units, and then at a random time the large drop detaches and deposits onto the print surface. Although good operation of the 3DP machine would avoid having this occur, if such an event does it is especially worthwhile to detect it. This can be detected by analysis of either the analog signal or the discretized signal. The analog signal would display a magnitude of shadow signal far larger than that for a normal drop or fluid unit, and so the event could be detected in that way. For example, a dispensed blob might even completely block almost all light. The duration of the signal would also be longer for a blob (randomly detached large drop) than that for a normal drop or fluid unit. A parameter combining signal magnitude and duration, such as an integral of magnitude over time, would also have a larger value than for a normal drop or fluid unit. Also, the passage of the large drop would probably be asynchronous compared to the dispensing of normal drops of fluid units. If a discretized signal is used, it would be possible to prepare a discretized signal for this purpose alone, whose threshold was such that only large undesirable drops were detected, or using a more ordinary threshold, large undesirable drops could be detected by their unusually long time duration. Any of this could result in an alarm, a stoppage of operations, or rejection of a printed article.

Determination of Flow Rate From Analog Signal

The shape characteristics (including the relative amplitude and width) of the analog signal from the preamplifier indicate the geometry of the fluid as it passes the detector. The detector can be thought of as a horizontal line aperture that views the passing material's two-dimensional shadow projected by the transmitter's illumination. Therefore, the analog signal level represents the width of the shadow viewed through this aperture, and if the material is axially symmetrical, can be interpreted as the instantaneous volume of the material. Thus, the area under the signal curve, the integral under one droplet cycle, represents the volume of fluid dispensed during that time. As long as the time period of integration is exactly one drop-to-drop interval, and as long as the identical pattern repeats itself in successive dispensings, it actually is unnecessary to synchronize the start of the integration interval with a dispense command. This provides some independence from the possible variation in time-of-flight, i.e., not exactly knowing how much after the dispense command it is until the fluid unit passes through the optical detection region.

Calibration of absolute volume requires that: (a) the preamplifier's output be linearized to compensate for the intrinsic non-linear behavior of the photodiode with respect to light intensity; (b) the aperture size allows adequate discrimination of shadow width; and (c) the droplet structures are axially symmetrical. Calibration of absolute volume is particularly relevant for measuring active ingredient of drug volume which is the process variable of interest for pharmaceutical products.

Determination of Fluid Stream Regime From Analog Signal

FIGS. 5A-E illustrate the changes in amplitude of the preamplifier output signals that correspond to different geometries of binder material passing by the detector typically encountered when using the 3DP microvalve drop-on-demand printhead technology.

AC coupling is used on the analog signal in the form of a capacitor in series with the signal to block out the DC component of the signal. This removes the constant value which represents the constant magnitude of illumination from the light source. Other possible very slow variations are also filtered out of the analog signal. Those very slow variations may represent extraneous influences such as aerosol buildup on the fiber ends, and minor mechanical stresses on the optical fiber. This is done after converting the light signal into an electronic signal, but before the signal is further amplified and compared against the threshold values. Filtering out the constant value and these possible extraneous influences allows the droplet information to pass through the filter in a form which ensures that it will be properly used by the discretization as compared against the threshold value. One example of an extraneous influence is mechanical stresses on optical fibers. Severe mechanical stresses cause permanent attenuation of light transmission in the fiber.

Analysis of the analog output signal in the frequency domain can be used to determine droplet stream characteristics as well. The following examples describe how droplet stream characteristics can be detected in the Fourier transform of the analog output signal:

1. Stream with stable droplet formation will contain a very large peak at the frequency of droplet delivery (generally in the range of 800 to 1000 Hz for microvalve-based printheads), with considerably less harmonic content above that frequency.

2. Droplets with concentric satellites will produce a fairly large peak at twice the droplet delivery frequency.

3. An unstable droplet stream will produce a broader peak at the droplet delivery frequency along with other frequency components that may or may not be related to the droplet frequency.

4. While more difficult to detect, a droplet stream that is drifting over time (often caused by changes in ambient and valve body temperatures), if periodic, will contain low frequency components indicating the rates of drift.

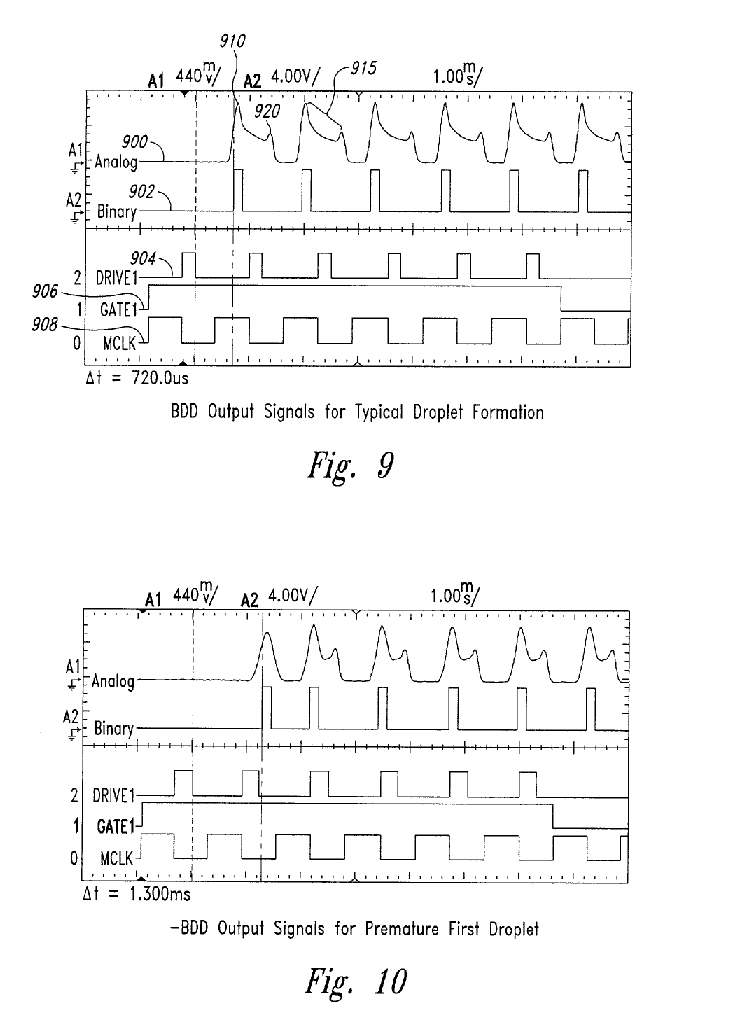

The following images illustrated in FIGS. 9 through 16 were captured on an HP54645D oscilloscope while recording the valve drive and binary droplet detection output signals of a single microvalve channel during the delivery of a flow measurement sample configured for printing 3×3×2.5 mm tablets. The sample was taken on the first TheriForm™ 3200 machine's 16-dispenser printhead at steady state while stationary.

### Case 1—Typical Droplet Formation

Test conditions: 80% propylene glycol/20% Deionized Water binder at 16 psi, detection threshold=0.5V, valve supply voltage=40V, Valve pulsewidth=224 μsec, room temperature=approx. 22° C.

FIG. 9 is a graph of traces illustrating output signals for typical droplet formation in accordance with the principles of the present invention. The top trace of FIG. 9, labeled “Analog,” 900 shows the output of the droplet detector photodiode preamplifier (photodiode preamplifier feedback resistor=221 KΩ). The shape of this waveform is typical of a droplet stream when viewed close to the dispenser exit prior to droplet break-off. The initial peak 910 is the main droplet body where the majority of the fluid is contained, the following down-sloping plateau 915 represents the “tail” and the minor peak 920 at the right-most edge of the pulse is a smaller droplet attached to the end of the tail. When the operating parameters are properly set, all of this material eventually breaks off and forms a single spherical droplet farther away from the dispenser which, if viewed at the break-off point, would appear as a single narrow peak without the plateau portion in the analog signal. Note that the overall width of the analog signal for the first droplet is slightly less than the following droplets, indicating a slightly smaller droplet volume.

The second trace, labeled “Binary,” 902 is the digitized version of the droplet detector output. This pulse train is required by the hardware utilized in the signal processing platform to provide reliable and consistent counting of the droplets detected at the printhead output. The width of the pulses are controlled by a programmable threshold function on the BDD system's fiberoptic interface board. This threshold determines the absolute voltage level at which the analog signal is considered to represent a “droplet” as opposed to a tail or other forms of noise or interference. Adjustment of this threshold serves two main purposes: (1) it allows the system to reject undesirable portions of the signal, such as tails, smaller satellites or electrical noise; and (2) to enable measurement of the width of various signal features, if desired.

The third trace, labeled “DRIVE1,” 904 shows the pulses that are used to control the microvalves (a high level opens the valve). Measuring the time between the falling edge of this signal and the rising edge of the “Binary” signal indicates the partial time-of-flight of the droplet, which, in this case, is 920 μsec. The time-of-flight measured here is only the time for the droplet to reach the sensor position; additional time is required for the droplet to reach the build bed surface. The total time-of-flight would be determined by measuring the droplet velocity and projecting the droplet's travel to the powder bed, calculating the flight time given the velocity and total travel distance.

The fourth trace, labeled “GATE1,” 906 is used to control the application of droplets to the build bed. In other words, when this signal is a high level, the next available drive pulse is sent to the microvalve switching circuitry to open the valve. Drive pulses are synchronized to the Master Clock, shown for reference on the bottom trace, labeled “MCLK” 908. The Master Clock signal's primary role is to synchronize the droplet position with the motion control system fast axis position.

### Case 2—Premature First Droplet

Test conditions: 80% propylene glycol/20% DI Water binder at 16 psi, detection threshold=0.5V, valve supply voltage=24V, Valve pulsewidth=311 μsec, room temperature=approx. 23° C.

FIG. 10 is a graph of traces illustrating output signals for premature first droplets in accordance with the principles of the present invention. In this example, a lower pulsewidth setting was used to achieve a lower flow rate. At this setting, the first droplet breaks off earlier than in the preceding typical case. This “premature” droplet is also significantly smaller, which can be determined by comparing relative areas under the analog curves for each droplet.

The plateau width for the droplets in this case is smaller than the typical case shown above, indicating both a lower overall droplet volume (flow rate)—as expected —and a shorter tail. This droplet stream will experience break-off closer to the dispenser than in the typical case, which can be confirmed by visual observation with a strobe.

Another important feature of this case is that the time-of-flight for the first droplet (1.3 msec) is longer than for the other droplets, resulting in an unequal droplet spacing and, hence, the velocity of the first droplet is slower than that of the following droplets.

### Case 3—Merging of First Two Droplets

Test conditions: 80% propylene glycol/20% Deionized Water binder at 16 psi, detection threshold=0.5V, valve supply voltage=24V, Valve pulsewidth=300 microseconds, room temperature=approx. 23° C.

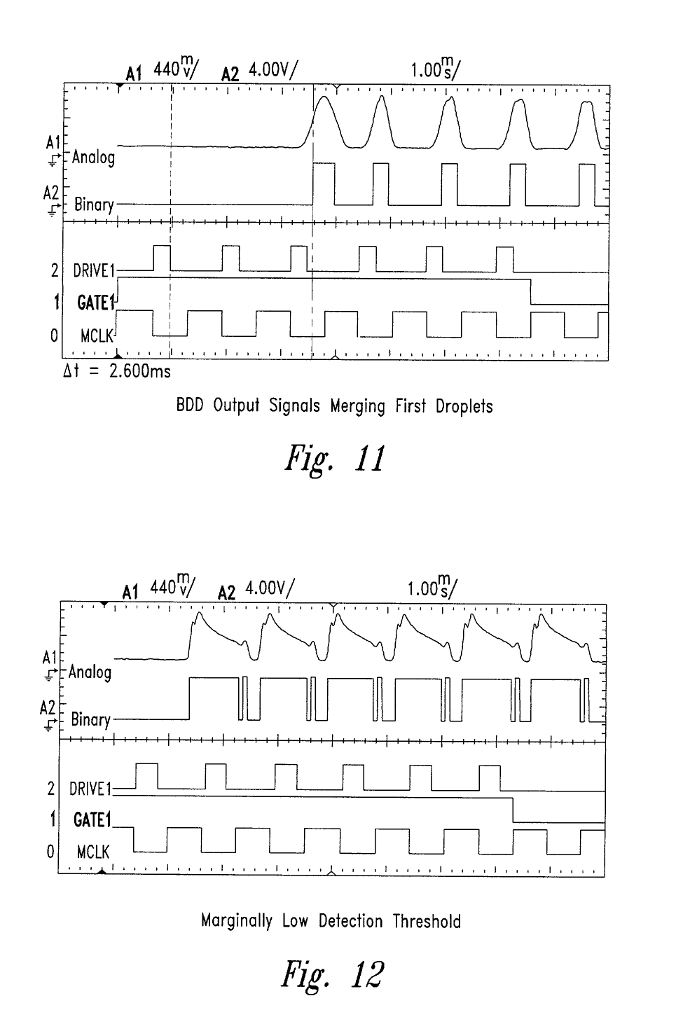

FIG. 11 is a graph of traces illustrating output signals merging first droplets in accordance with the principles of the present invention. In this case, a very low pulsewidth resulted in merging of the first two droplets to form a single, larger droplet, which is indicated again by the larger area under the analog curve relative to the other droplets. As a result, only five of the six droplets in this packet would actually be counted by the binary detection system.

The plateaus caused by tails are missing altogether, indicating very early droplet break-off, which can be confirmed with visual observation using strobed illumination.

Again note the differences in time-of-flight for the first droplet versus the following droplets. The time-of-flight of the first double droplet is considerably longer (2.6 msec) than the two preceding cases as are, to a lesser degree, the times-of-flight for the following droplets.

Operation of the microvalves in this minimum flow rate regime should be avoided, because along with poor initial droplet formation, a very low droplet velocity and size would likely result in greater placement errors and stream stability.

Effects of Varying Detection Threshold

1. Threshold Too Low

Improper setting of the detection threshold can result in incorrect counting by introducing additional pulses or missing pulses. The following examples illustrate how differences in detection threshold can affect the output of the binary detection system.

FIG. 12 illustrates the effect of a detection threshold that is too low to properly detect a single droplet peak. In this case, the secondary peak of the terminal droplet is counted as another droplet, while the analog waveform indicates that this secondary peak is still part of the same “packet” of binder that will eventually form a spherical droplet.

2. Baseline Shift

Buildup of binder on the detector resulting from aberrant streaming causes a baseline shift in the analog signal due to changes in the coupling of quiescent light to the optical fiber end. A shift in the baseline effectively changes the detection threshold, since the threshold is always relative to the zero-volt output of the preamplifier in the quiescent state. Baseline shift can be detected digitally by observing the comparator state when different thresholds are written to the interface board. When a baseline shift is detected, the host can respond in at least two ways: inform the operator that buildup may be occurring indicating aberrant streaming conditions that must be corrected before continuing; and/or compensate for the shift by changing the threshold by a corresponding amount. Baseline shift errors can be eliminated using the AC coupling technique described earlier.

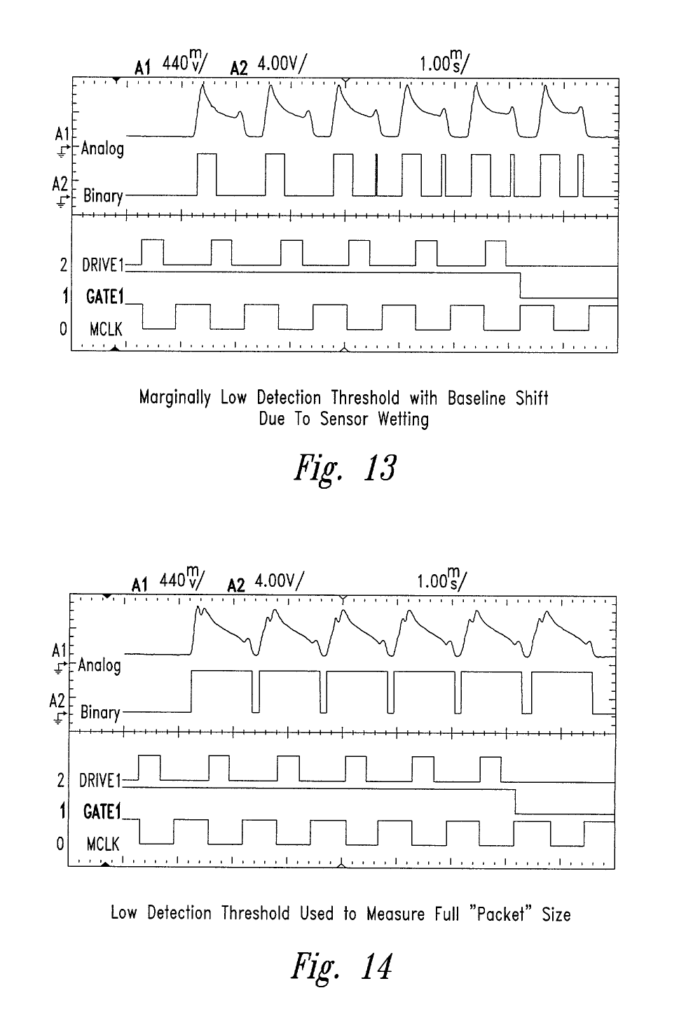

FIG. 13 shows how even a small a baseline shift can start to introduce errors in the droplet count by subtly injecting additional pulses into the digitized signal, especially when the detection threshold is set at a marginally low level. In this example, the binary detection system would indicate that 10 droplets were delivered when only six were commanded. This example also illustrates how the droplet stream is changing within a single printed tablet; specifically, that the secondary peak is increasing slightly with each droplet, indicating a small increase in droplet volume and possibly differences in droplet break-off distance.

3. Using the Detection Threshold to Measure Signal Features

The detection threshold can also be applied in ways that enable measurement of the width of various signal features, namely main droplet width or full “packet” width. If the threshold is intentionally set very low, the width of the resulting pulse corresponds to the volume of binder in each droplet. This technique may be used to estimate relative changes in volumetric flow rate, and with proper calibration and time measurement resolution, may be used to determine absolute volumetric flow rate.

Measurement of main droplet peak width can be achieved by setting the detection threshold high enough to reject the tail and secondary peaks; this represents the typical operating mode of the binary detection system (refer to FIG. 3). Peak width may provide a means to predict droplet quality and break-off length, though this has not yet been shown experimentally.

FIG. 14 shows how a low detection threshold can be used to measure full packet width.

First Droplet Phenomena

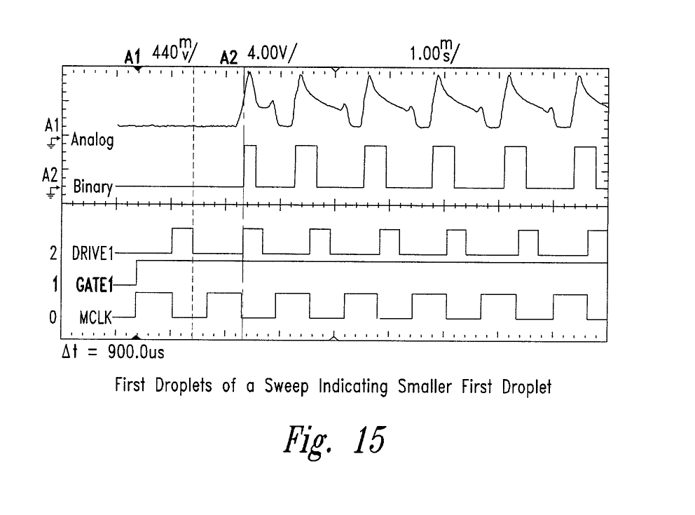

FIG. 15 shows the first six droplets that would be printed in a single sweep. Note that the first droplet has both a shorter tail and a lower volume than the following droplets. In this case, the pulsewidth—hence flow rate—is relatively high, so there is sufficient energy to produce the initial droplet. However, observations during test print runs indicate that in some cases, depending on pulsewidth, microvalve drive voltage, binder viscosity and pressure, the first droplet of a sweep may be missing altogether, or may be improperly formed (as discussed in Case 2 above). Note that the velocity of the first droplet is slower than the following droplets as evidenced by the longer time-of-flight.

It is further possible to analyze a signal, for the purpose of distinguishing between fluid flow regimes, by means of a Fourier transform of the signal which describes the light intensity as a function of time. FIGS. 14A-C present the Fourier transforms of the signal waveforms for three different flow regimes. In all cases the flow stream was generated by actuating a microvalve at a frequency of 800 Hz.

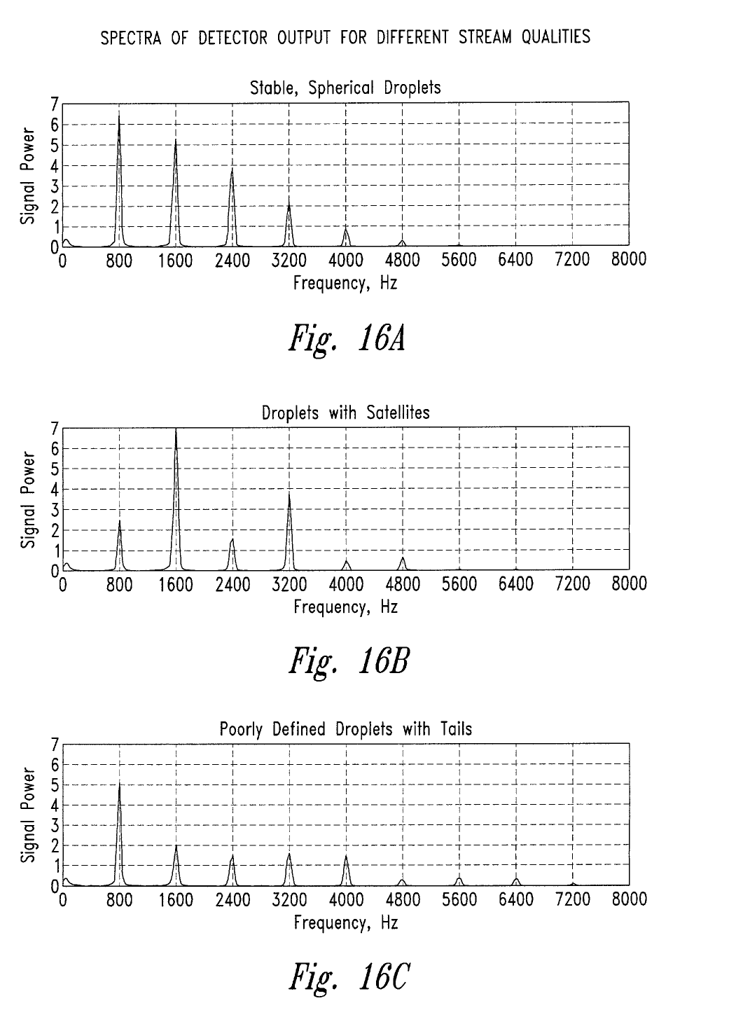

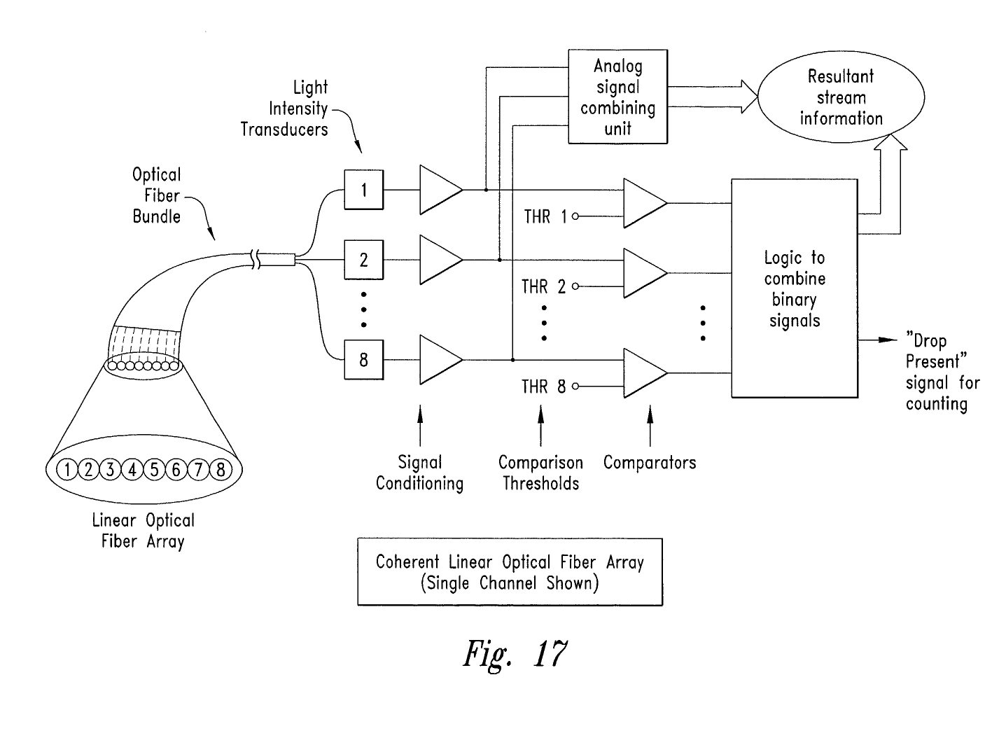

As illustrated in FIG. 16A, the first Fourier transform is for a stream of identical stable spherical droplets. The largest component is the 800 Hz (first harmonic) component, which is the frequency of operation of the microvalve. The magnitudes of the higher harmonics decrease in a smooth regular fashion resembling the Fourier transform of a triangle wave.

As illustrated in FIG. 16B, the second Fourier transform is for a stream which contains a satellite droplet in between each regular drop. In this case there are essentially 1600 drops per second rather than 800 drops per second, alternating in size in the pattern large/small/large/small, etc. Accordingly, the Fourier transform has its peak magnitude at a frequency of 1600 Hz (which is the droplet frequency or twice the valve actuation frequency), rather than 800 Hz (the valve actuation frequency). It can also be noted that the next largest component magnitude is 3200 Hz, which is a harmonic of the droplet frequency. This is significantly different from the pattern in the first Fourier transform. It can be used to distinguish the satellite regime from the regime of discrete stable spherical droplets.

As illustrated in FIG. 16C, the third Fourier transform is for a flow regime in which the droplets are somewhat more connected, poorly defined droplets with tails. In this Fourier transform, the harmonic with the largest magnitude is the frequency of the valve actuation, just as in the first case. However, the magnitude of all of the higher harmonics is much smaller than the magnitude of the higher harmonics in the first case of discrete identical droplets. Also, there are measurable magnitudes of harmonics even as high as 7200 Hz (nine times the valve operation frequency), which is higher than for the first case. This observation can be used to distinguish poorly defined droplets with tails from well-defined stable spherical droplets.

Line-Array Sampling From a Coherent Optical Fiber Bundle or From an Array of Incoherent Fibers

By forming an array of incoherent fibers in a line perpendicular to the fluid stream and fixing the relative fiber positions identically on both ends, a coherent linear array light intensity detector could be formed. This type of light intensity detector could be used to provide a greater degree of information about the droplet and stream characteristics using signal processing techniques that are substantially similar to the incoherent optical fiber detector, and less complex than two-dimensional image processing techniques. In addition, the linear fiber array would likely require less height below the dispensing dispensers—where the space is already quite limited—than the coherent optical fiber bundle.

The same signal processing circuitry used for the incoherent optical fiber detector (shown in FIG. 7) could be applied to each of the single optical fibers within the coherent linear optical fiber array, then combined to yield additional information about the droplet and stream characteristics. Combining the signal provided by each individual optical fiber in the linear array could be done through, for instance, a weighted summation of the analog signals or through combinatorial logic applied to the discretized (binary) signals, or both. The resultant signal could then be processed using any of the signal processing techniques discussed in this invention.

For example, by comparing relative intensities among the individual optical fibers in the linear array, it would be possible to determine the angle of the droplet stream relative to the dispensing dispenser so that streams deviating from a predetermined acceptable angle could be detected and corrective action taken. In another example, multiple minima in the light intensity pattern across the linear optical fiber array could be interpreted as an aberrant flow regime known as “split streaming” in which foreign matter in or around the dispensing orifice disrupts the normal single stream of fluid; this split streaming is a highly undesirable flow regime because it can cause significant errors in droplet placement resulting in incorrect 3DP structures. The same type of analysis could be done with selected individual fibers from a coherent fiber bundle selected to lie along a horizontal line.

Further Discussion

The invention has been described with an optical configuration which could be described as backlighting, i.e., the light source, and the fluid stream, and the light receiver being substantially in line with each other and in that order. However, it should be appreciated that other optical configurations are also possible. The light receiver could look at the fluid stream from essentially any angle relative to the direction of illumination, including looking at light reflected from the fluid stream rather than detecting the blockage of light by the fluid stream.

In three-dimensional printing it is appreciated that there is time-of-flight of droplets or fluid units from the dispenser to the printing surface. Calculations of time-of-flight could be included in the systems described here such as in determining time delays for triggering for various signal acquisition or other actions. Time-of-flight calculations could involve the time of flight of fluid from the dispenser to the fiber optic viewing region, or from the dispenser to the printing surface, or other similar quantities.

It should be appreciated that a printhead may contain multiple dispensers and the fiber optic systems of the present invention could be applied to any number of the dispensers on a printhead.

Threshold values used in discretization could be adjusted if necessary as a result of gradual change in system behavior such as depositing of aerosol on the ends of the optical fiber near the printhead (which could also be remedied by cleaning) or slight change in the amount of permanent attenuation in the optical fiber as a result of possible severe mechanical stress.

Signal processing techniques that could be applied to the incoherent fiber or coherent linear fiber array signals:

detection of satellites by looking for multiple peaks in the analog signal within a droplet dispensing interval.

using the width of the binary output pulse to determine if proper droplet break-off is occurring (a wider pulse is generated when a tail is present or if the flow rate is high enough to prevent proper break-off).

using multiple thresholds to provide multi-level discretization, or put another way, to provide a coarse digitization of the signal to indicate gross droplet shape or to look for specific features in the droplet shape indicating undesirable flow regimes.

In general, techniques of signal processing that could be applied to the analog signal including, in addition to Fourier transforms, offsets and inversions, various other filtering, sampling, analyzing and waveform modification and statistical analysis techniques including techniques performed by Digital Signal Processing (DSP).

Furthermore, the present invention as described and claimed is applicable to a variety of dispensing situations including, three-dimensional printing, dispensing reagent into microtiter plates in combinatorial chemistry applications and two-dimensional printing. Combinatorial chemistry applications involve moving a robotically-controlled dispenser similar to three-dimensional printing applications.

Throughout the application, fluid, fluid unit, and droplet are used interchangeably to indicate a unit of fluid that may be either a discrete drop or another geometric form in which fluid is dispensed from one dispense command.

From the foregoing it will be appreciated that, although specific embodiments of the invention have been described herein for purposes of illustration, various modifications may be made without deviating from the spirit and scope of the invention. Accordingly, the invention is not limited except as by the appended claims.

We claim:

1. Apparatus for obtaining information about a fluid issuing from a moving dispenser during printing, comprising:
a dispenser for dispensing fluid, the dispenser having an orifice wherein the fluid flows out of the orifice of the dispenser and moves away from the orifice of the dispenser in a substantially vertical path;
a light source directing light toward the path of the fluid;
a receiver optical fiber having a first end and a second end, the first end of the receiver optical fiber being proximately positioned to maintain a relative distance from the path of the fluid, the first end of the receiver optical fiber receiving variations in light intensity as the dispensed fluid blocks a portion of the light, the second end of the receiver optical fiber connected to a light receiving device for monitoring the variations in light intensity, wherein a length of fiber between the first end and the second end of the optical fiber is sufficiently flexible to accommodate movement of the dispenser.

2. The apparatus of claim 1, wherein the light source is transmitted through a transmitter optical fiber, the transmitter optical fiber being proximately positioned to maintain a relative distance from the path of the fluid.

3. The apparatus of claim 1, wherein the light source is a light emitting diode.

4. The apparatus of claim 1, wherein the receiver optical fiber is an incoherent optical fiber.

5. The apparatus of claim 4, wherein light from the light source is emitted in a beam that is substantially continuous in time.

6. The apparatus of claim 4, wherein light from the light source is emitted in a stroboscopic pattern that varies with time and the light receiving device produces an analog signal wherein peaks in the analog signal correspond to a dispensed fluid unit.

7. The apparatus of claim 6, further including a controller for controlling the fluid dispensing from the dispenser and wherein the stroboscopic light source pattern is triggered by commands given to the dispenser.

8. The apparatus of claim 1, wherein the light receiving device is a light intensity transducer wherein the light intensity transducer produces an analog time-dependent electrical signal whose magnitude is related to an intensity of the light exiting the optical fiber.

9. The apparatus of claim 8, further comprising a Fourier transform device that transforms the time-dependent electrical signal into a frequency spectrum.

10. The apparatus of claim 8, further comprising a discretizer that identifies parts of the time-dependent electrical signal as dispensing of a fluid unit.

11. The apparatus of claim 10, further comprising a counter, which counts the number of times the discretizer identifies parts of the time-dependent electrical signal as dispensing of a fluid unit.

12. The apparatus of claim 10, further comprising a recording device that records the discretizer identifying parts of the time-dependent electrical signal as dispensing of a fluid unit.

13. The apparatus of claim 12 wherein the recording device further records the spatial location of the dispenser at the time of the discretizer identifying parts of the signal as dispensing of a fluid unit.

14. The apparatus of claim 13 wherein the recording device further records commands for dispensing to compare actual dispensed fluid to theoretical commanded dispensed fluid.

15. The apparatus of claim 1 wherein the receiving optical fiber is a coherent optical fiber bundle.

16. The apparatus of claim 15 wherein the light source emits light in a substantially continuous beam.

17. The apparatus of claim 15 wherein the light source emits light in a stroboscopic pattern.

18. The apparatus of claim 17 wherein the stroboscopic light source is triggered by commands given to the dispenser.

19. The apparatus of claim 15 wherein the light receiving device is a camera.

20. The apparatus of claim 19, further including an image processing device connected to the camera.

21. The apparatus of claim 20, wherein the image processing device is capable of measuring diameter or cross-sectional area or other dimensions of fluid structures.

22. The apparatus of claim 1, wherein a plurality of dispensers are mounted in a printhead and the printhead contains more than one light source and an optical fiber associated with each light source.

23. A method of obtaining visual information about a fluid from a moving printhead as the printhead is printing product, comprising:
dispensing the fluid from the printhead along a fluid path;
shining light from a light source toward the fluid path such that the light beam intersects that fluid path;
receiving light into an optical fiber, as the fluid passes through the light;
moving the printhead wherein the optical fiber is flexible and has two ends and one end is able to move with the printhead during operation; and
carrying the received light to a light receiving device.

24. A method of counting fluid units dispensed from a moving printhead, comprising:
dispensing the fluid from the printhead along a fluid path;
shining light from a light source toward the fluid path such that the light beam intersects that fluid path;
receiving light into an optical fiber, as the fluid passes through the light;
moving the printhead wherein the optical fiber is flexible and has two ends and one end is able to move with the printhead during operation;
carrying the received light to a light receiving device;
converting the received light to a discretized signal representing dispensed fluid units; and
counting the number of dispensed units.

25. A method of determining a flow characteristic of a fluid stream dispensed from a moving printhead, comprising:
dispensing a fluid from a printhead along a fluid path;
shining light from a light source toward the fluid path such that the light beam intersects the fluid path;
receiving light after it passes the fluid blocks a portion of the light from the receiving optical fiber, the optical fiber bending to accommodate movement of the printhead;
carrying the received light to a fixed instrument;
converting the received light to a time-dependent electrical signal;
analyzing the time-dependent electrical signal in the form of a frequency spectrum having various harmonics; and
comparing the relative magnitudes of various harmonics in the frequency spectrum to determine the flow characteristics of the fluid stream.

26. A method of bring visual information to a camera from a printhead as the printhead is printing product, using a coherent optical fiber bundle, comprising;
obtaining a picture of fluid dispensing near a printhead while the printhead is actually printing a product; and
transmitting the picture from a moving printhead through a coherent optical fiber bundle while the coherent optical fiber bundle is bending or changing shape as the picture is being transmitted through it.

27. The method of claim 26 further including using visual dimensional data with records of numbers and timing of drops to calculate volumetric flow rate or velocity or other stream characteristics of the fluid being dispensed.

28. The method of claim 26 further including using colorimetric analysis of the returned light to obtain information about the chemical content of the fluid being dispensed.

29. The method of claim 26 further including using any of the data as feedback to control or adjust printing parameters, or as a quality assurance record of the printing process.

30. A method of controlling the output of a three-dimensional printer, comprising:
measuring a characteristic of a discharged fluid by optical means; and
adjusting an operating parameter of the three-dimensional printer in response to the measured characteristic of the discharged fluid.

31. A verification system for use with a three-dimensional printer, comprising:
means for determining a delivery of units of a fluid;
means for recording information about the delivery of units of the fluid; and
means for comparing the information about the delivery of units of fluid with information about command for delivery of units of fluid.

32. A method of obtaining information about a dispensed fluid, comprising:
projecting a light beam across a fluid path;
dispensing fluid from a dispenser upon a command signal through the fluid path;
receiving variations in light intensity due to the dispensed fluid moving through the light beam; and
producing an analog signal from the received variations in light intensity.

33. The method of claim 32 wherein an incoherent optical fiber receives the variations in light intensity.

34. The method of claim 33 wherein the analog data from the incoherent fiber is used to estimate flow rate by processing the signal using algorithms to integrate a dispensing interval.

35. The method of claim 32 wherein a coherent fiber bundle receives the variations in light intensity to provide an image of the dispensed fluid.

36. The method of claim 35 further including calculating fluid dimensions from the variations in light intensity.

37. The method of claim 35 further including displaying multiple images on one display screen.

38. The method of claim 32 further including, discretizing the analog signal by comparing an instantaneous magnitude of the analog signal against a threshold value so as to indicate either the presence or absence of a drop.

39. The method of claim 32 further including, recording a binary signal from the received variations in light intensity.

40. The method of claim 32 further including counting fluid units crossing the fluid path in real-time.

41. The method of claim 32 wherein the analog signal goes through a Fourier Transform and/or other signal processing algorithms for the purposes of diagnosing a regime of the dispensed fluid, wherein the regime is one of individual droplets, satellites, connected bulges, intermittent streams, connected drops or streams.

42. The method of claim 32 wherein a coherent fiber bundle receives the variation in light intensity to provide a one-dimensional line array of individual fibers, wherein the one-dimensional line array can detect split-streaming or off-axis streaming of the dispensed fluid.
